(19) United States
(12) Patent Application Publication
(10) Pub. No.: US 2025/0170778 A1
(43) Pub. Date: May 29, 2025

(54) TECHNIQUE FOR POWDER REMOVAL FROM A THREE-DIMENSIONAL WORKPIECE GENERATED VIA ADDITIVE MANUFACTURING

(71) Applicant: NIKON SLM SOLUTIONS AG, Luebeck (DE)

(72) Inventors: Stefan Wortmann, Luebeck (DE); Daniel Kopschinski, Luebeck (DE)

(21) Appl. No.: 18/842,642

(22) PCT Filed: Apr. 26, 2023
(86) PCT No.: PCT/EP2023/060882

§ 371 Date: Aug. 29, 2024

(30) Foreign Application Priority Data
Apr. 28, 2022 (DE) 10 2022 110 345.5

(51) Int. Cl. B29C 64/35; B29C 64/357; B29C 64/379; B33Y 40/20

(52) U.S. Cl. CPC B29C 64/35; B29C 64/357; B29C 64/379; B33Y 40/20

(57) ABSTRACT

A method for powder removal from a three-dimensional workpiece generated via additive manufacturing is provided. The method comprises mounting a build cylinder to a build cylinder fixture. The build cylinder comprises a base plate holding the three-dimensional workpiece and sidewalls separably attached to the base plate. The build cylinder comprises residual powder from an additive manufacturing process of the three-dimensional workpiece. The method further comprises attaching a foil to the build cylinder fixture and/or to the base plate. Further, a device for powder removal from a three-dimensional workpiece generated via additive manufacturing is provided.

The present invention generally relates to powder removal from a three-dimensional workpiece generated via additive manufacturing. The powder removal may be considered as part of a so-called unpacking process of the three-dimensional workpiece. The process of additive manufacturing may be, without limitation, powder bed fusion, such as selective laser sintering, selective laser melting, or electron beam melting.

Powder bed fusion is an additive layering process by which pulverulent, in particular metallic and/or ceramic raw materials can be processed to three-dimensional workpieces of complex shapes. To that end, a raw material powder layer is applied onto a carrier and subjected to radiation (e.g., laser or particle radiation) in a site-selective manner in dependence on the desired geometry of the workpiece that is to be produced. The radiation penetrating into the powder layer causes heating and consequently melting or sintering of the raw material powder particles. Further raw material powder layers are then applied successively to the layer on the carrier that has already been subjected to radiation treatment, until the workpiece has the desired shape and size. Powder bed fusion may be employed for the production of prototypes, tools, replacement parts, high value components, or medical prostheses, such as, for example, dental or orthopedic prostheses, on the basis of CAD data. Examples for powder bed fusion techniques include selective laser melting, selective laser sintering, and electron beam melting.

Apparatuses are known for producing one or more workpieces according to the above technique. For example, EP 2 961 549 A1 and EP 2 878 402 A1, respectively, describe an apparatus for producing a three-dimensional workpiece according to the technique of selective laser melting. The general principles described in these documents may also apply to the technique of the present disclosure.

Once, the three-dimensional workpiece has been generated layer by layer within the powder bed, residual powder has to be removed from the workpiece, such that the workpiece can be used and/or further processed. During the removal of the powder, contamination with surrounding air (in particular, oxygen) should be avoided to avoid, e.g., oxidation. Further, the generation of dust clouds should be avoided or controlled by inertisation in order to avoid, e.g., explosions. It is therefore desirable that the removal of the powder takes place in a controlled environment (e.g., in an inert gas atmosphere such as argon atmosphere) and under controlled conditions.

Residual powder may refer to unsolidified powder within a build cylinder, in which the workpiece was solidified and thereby built. After one or more processes of reprocessing (such as cleaning, drying, sieving, etc.), the residual powder may be fed back to the building process and a new three-dimensional workpiece may be generated out of the residual powder.

Several techniques are known for removing residual powder from a workpiece. For example, sidewalls of the build cylinder may be moved upwards while a base plate of the build cylinder stays on the ground. This technique, however, may cause explosive dust clouds. Further, an additional axis of movement is necessary for this technique and a complicated technique for collecting the trickling residual powder in a storage container is required.

Further, it is known to press a base plate of the build cylinder upwards while the sidewalls of the build cylinder stay on the ground.

One problem of these prior art techniques is that the workpiece and potentially remaining residual powder at the workpiece are transported for further processing while being exposed, at least temporarily, to a surrounding atmosphere. Furthermore, residual powder may spread in the surrounding atmosphere.

The invention is therefore directed at the object of providing a technique that solves at least one of the aforementioned problems and/or other related problems. In particular, and without limitation, an improved powder removal technique is desired, wherein the workpiece and residual powder are subjected to a surrounding atmosphere as little as possible. In particular, and without limitation, an improved powder removal technique is desired, wherein a contamination of a surrounding atmosphere is reduced and, thereby, operational safety is enhanced.

This object is addressed by the subject-matter of the independent claims. Advantageous embodiments are indicated in the dependent claims.

According to a first aspect, a method for powder removal from a three-dimensional workpiece generated via additive manufacturing is provided. The method comprises mounting a build cylinder to a build cylinder fixture. The build cylinder comprises a base plate holding the three-dimensional workpiece and sidewalls separably attached to the base plate. The build cylinder comprises residual powder from an additive manufacturing process of the three-dimensional workpiece. The method further comprises attaching a foil to the build cylinder fixture and/or to the base plate.

One or more of the following features of the method aspect may also apply to the apparatus of the apparatus aspect described below. When, in the present disclosure, the term “workpiece” is used, it always refers to the “three-dimensional workpiece”.

The method may be carried out by a device for powder removal, which may be part of a so-called unpacking station. The additive manufacturing process, with which the workpiece has been generated, may be selective laser melting or selective laser sintering or any other process, in which powder is solidified and/or bonded to form a three-dimensional workpiece.

Hence, the build cylinder may be a build cylinder used in an apparatus for additive manufacturing, such as a selective laser melting apparatus or a selective laser sintering apparatus. The build cylinder may comprise a lid in order to maintain an inert atmosphere within the build cylinder. For example, the build cylinder may be closed with the lid within the apparatus for additive manufacturing, while the build cylinder is still in inert atmosphere (e.g., argon atmosphere). Alternatively, a hopper or funnel might be attached to the build cylinder inside the selective laser sintering apparatus maintaining an inert atmosphere. Then, the closed build cylinder may be moved to the unpacking station, where the process according to the first aspect is carried out.

Powder removal from the three-dimensional workpiece generally means, according to the present application, powder removal from an inner volume of the build cylinder while the workpiece is held by the base plate. Hence, the removed powder may or may not have been in direct contact with the workpiece.

The build cylinder may have an inner volume having the form of a general cylinder. Hence, the cylinder may be a circular cylinder (with a circular base plate) or the base plate may have, e.g., a rectangular shape, a square shape, a rectangular shape with rounded corners, an elliptical shape, etc. The base plate of the cylinder may extend in a horizontal x-y-plane, whereas the sidewalls of the cylinder are perpendicular to the base plate and extend, e.g., parallel to a z-direction. The base plate may correspond to a carrier that is moved downwards relative to the sidewalls, during the additive manufacturing process.

The build cylinder fixture may comprise, e.g., a plate, to which the build cylinder is mounted (i.e., attached). The mounting may be carried out via one or more mounting members, such as screws, pins, clamps, etc. The mounting may guarantee a stable but releasable connection of the build cylinder to the build cylinder fixture. The build cylinder fixture may be attached to manipulation means, such as at least one or more motors, at least one or more actuators, at least one or more vibration devices, etc. In particular, the build cylinder fixture may be attached to a robot end effector.

The fact that the base plate is holding the workpiece may mean that the workpiece has been generated onto the base plate during the additive manufacturing process. Hence, the workpiece may be directly connected to the base plate since a first layer of the workpiece is directly bonded to the base plate. However, the workpiece may also be indirectly bonded to the base plate via one or more support structure extending from the base plate to the workpiece. Further, the workpiece may have been attached and secured to the base plate after the additive manufacturing process. Still further, the workpiece may be simply held via gravitational force on the base plate and, in this case, the workpiece is entirely surrounded by residual powder.

Residual powder, according to the present disclosure, may refer to unsolidified (or not bonded) powder in an inner volume of the build cylinder. In other words, residual powder is powder that has been applied to the base plate during the additive manufacturing process, but that was not solidified or bonded during the additive manufacturing process. In the unpacking station, it is an object to remove the residual powder as completely as possible from the workpiece.

The foil may be transparent. In this way, a user and/or a camera may observe the workpiece within the foil and may monitor the progress of removing powder from the workpiece. The foil may be a one-time use foil to ensure purity and safety with the transport/powder removal process. The foil may be a bag or sack.

The foil may be attached such that an opening section of the foil is attached to the build cylinder fixture and/or to the base plate. The opening section of the foil may be an opening section of a volume formed by the foil. In other words, when the opening section is closed, the foil may define a closed volume. However, the foil may also have more than one opening sections, e.g., in the case the foil is provided in the form of a tube-like foil. The opening section may comprise an opening, such as a hole. When the opening section is attached, an entire edge region of the opening section may be attached. For example, an entire edge of a hole formed in the opening section may be attached.

The attaching may be carried out in a gas-tight manner. The foil may be attached only to one of the build cylinder fixture and the base plate or to both of these elements. For example, the foil may firstly be attached to the build cylinder fixture (e.g., in a non-gas-tight manner) and subsequently be attached to the base plate in a gas-tight manner.

The workpiece may be enclosed by the foil in a manner that the workpiece is within an inner volume defined by the foil. This, however, does not necessarily mean that the workpiece is entirely surrounded by the foil and that the workpiece is in a closed volume defined by the foil. For example, the workpiece is also enclosed by the foil when the foil is a tube-like foil and the workpiece is located within an inner part (i.e., inner space) of the tube-like foil. It may therefore be said that “the three-dimensional workpiece is enclosed by the foil” or that “the three-dimensional workpiece is laterally enclosed by the foil”, after the step of attaching.

The method may further comprise separating the base plate from the build cylinder, while the foil stays attached to the build cylinder fixture and/or to the base plate.

Separating the base plate from the build cylinder may comprise separating the base plate from the sidewalls. Separating the base plate from the build cylinder may be carried out by moving the base plate relative to the sidewalls in a direction parallel to the sidewalls. During this movement, the workpiece may stay enclosed by the foil.

The foil may be a tube-like foil. In the step of attaching, an opening section of the tube-like foil may be attached to the build cylinder fixture and/or to the base plate. The opening section of the foil may correspond to one end section of two opposite end sections of the tube-like foil.

With regard to the opening section, see the above explanation. The tube-like foil may be an endless foil. In other words, the tube-like foil may be configured to be used for several processes according to the first aspect, e.g., at least 10, at least 20, at least 50, or at least 100. An extension of the tube-like foil into a direction between the two end sections, in an unfolded state, may be at least 5 times of a diameter of the opening section, at least 10 times of a diameter of the opening section, at least 20 times of a diameter of the opening section, at least 30 times of a diameter of the opening section, at least 50 times of a diameter of the opening section, or at least 100 times of a diameter of the opening section.

The method may further comprise, after the step of separating the base plate from the build cylinder, pinching off the tube-like foil in a region of the tube-like foil between the one end section and the other one of the two opposite end sections, such that the tube-like foil forms a closed volume around the thee-dimensional workpiece.

Pinching off may refer to a process of separating a volume of the tube-like foil into separate volumes. The pinching may be powder-tight and, optionally, gas-tight. The pinching may be carried out with a pinching member, such as a wire, a rubber band, a cable tie, a clamp, etc. The pinching may also be carried out by forming a knot. After the step of pinching, the separate volume may be cut off from a remaining part of the tube-like foil.

The method may further comprise, after the step of separating the base plate from the build cylinder, shrinking the foil surrounding the three-dimensional workpiece, e.g. to reduce the gas volume inclosed within the foil.

The opening section of the tube-like foil may be attached to the base plate by using a clamp device surrounding the base plate and clamping the tube-like foil between the clamp device and the base plate.

The base plate may comprise a circumferential groove, wherein the clamp device engages into the groove. The clamp device may comprise a wire, a rubber band, a cable tie, a clamp (e.g., metallic), etc. The clamp device may be configured to apply a radial force to the base plate, thereby clamping the tube-like foil to the base plate. The attaching via the clamp device may be powder-tight and, optionally, gas-tight.

The method may further comprise removing the base plate from the build cylinder fixture.

The base plate may be removed together with the workpiece and the foil forming a closed volume around the workpiece. After removing the base plate, the base plate may be moved to a further station of storage or post processing.

The method may further comprise reusing the build cylinder fixture for a further process according to the method of claim 1.

Hence, a further build cylinder may be mounted to the build cylinder fixture. Thus, the build cylinder fixture may stay part of an unpacking station, whereas movable build cylinders are brought to the unpacking station from the additive manufacturing apparatus.

The tube-like foil may be stored in folded form in a foil storage. The foil storage may surround at least part of the build cylinder. The foil storage may alternatively be located under the build cylinder.

A diameter of the foil storage may be larger than a diameter of the build cylinder (more precisely, of a diameter of the base plate). The foil storage may be ring-shaped. The term ring-shaped as used herein may not only encompass circular ring-shapes but may also encompass non-circular ring-shapes such as square-shaped rings. In other words, it may be said that the foil storage is circumferential.

The method may also comprise a step, in which the static charge of the foil is prevented or reduced. Alternatively, a method for discharging the foil may be included.

The method may further comprise removing a lid of the build cylinder and replacing the lid with a funnel.

In a closed state, the lid may close the build cylinder gas-tight. Further, the funnel may close the build cylinder gas-tight. For this purpose, the funnel may comprise a valve that is closed during the time of the replacing.

The method may further comprise, after the step of mounting, rotating the build cylinder around a horizontal axis, such that the build cylinder is brought into an upside down position.

The definition “after the step of A, B” does not necessarily mean that step B follows directly subsequent to step A. Further steps may be carried out between A and B. The upside down position may mean that the build cylinder is rotated by 180° around the horizontal axis. In other words, in the upside down position, the base plate of the build cylinder points upwards. The funnel (if attached) may point downwards in the upside down position. Additional movements (e.g., vibrations, rotations, etc.) may precede the upside down state.

The method may further comprise opening a valve of the funnel, such that at least part of the residual powder flows downwards into a storage container.

In other words, the residual powder may flow from the build cylinder, through the funnel, into the storage container. The storage container may be connected to the funnel in a powder-tight, optionally in a gas-tight, manner.

The powder, that flows downwards, may pass at least one sieving station to remove coarse particles from the powder.

The sieving station may be configured to remove coarse particles from the residual powder, such as clumps, splashes, partially solidified powder, etc. This may prevent the coarse particles from entering the storage container. Hence, the powder in the storage container may be recycled with less steps of further processing.

The steps of attaching and separating may be performed in the upside down position.

Thus, the workpiece may be pulled out of the build cylinder (upwards) while being in an upside down position.

The method may further comprise vibrating and/or rotating the build cylinder and/or the base plate. Tools for vibrating the build cylinder or base plate may be included in the build cylinder fixture or might be supplied from outside the foil.

Vibrating and/or rotating the build cylinder at any time after the build cylinder has been mounted to the build cylinder fixture, may cause residual powder from become detached from the workpiece. This may enhance the removal of the residual powder.

The method may further comprise, after the step of attaching, inserting a tip of a vacuum device through an opening of the foil and vacuuming an inside region of the foil with the vacuum device to remove at least part of the residual powder.

The vacuum device may be a vacuum cleaner. The opening may be formed, e.g., by cutting. Further, the opening may already be present in the foil when the foil is attached. Similar to the vacuuming, other steps of manipulation (e.g., brushing, blowing, etc.) may be carried out through the opening and/or through a further opening of the foil.

The method may further comprise removing the clamp device and attaching a powder trap device to the tube-like foil, wherein the powder trap device has a powder entry section with sidewalls pointing inwards, and rotating the build cylinder around a horizontal axis, such that at least part of the residual powder is trapped inside the powder trap device.

The entry section may form a substantial one-way path for the powder. The entry section may be formed in the form of a funnel pointing inwards into the powder trap device.

The method may further comprise, in the upside down position, pinching off a section of the tube-like foil at a lower part of the tube-like foil, such that at least part of the residual powder is trapped within a closed volume formed by the tube-like foil.

In other words, a lower part of the tube-like foil, where residual powder has accumulated via gravitational force, is pinched off from a remaining volume. In this way, this powder does not fall back onto the base plate and/or into the build cylinder when the build plate or build cylinder is rotated back into its initial upright position (not the upside down position).

The foil may be powder-tight. Optionally, the foil may be gas-tight, in particular with regard to at least one of argon, nitrogen, and air. When the foil is powder-tight, this means that no powder can pass the foil. Thus, when the powder-tight foil forms a closed volume, no powder can exit the closed volume of the foil towards a surrounding atmosphere. Further, according to at least one embodiment, when the foil forms a closed volume filled with inert gas (such as argon or nitrogen), no inert gas can exit the closed volume and no air from the surrounding atmosphere can enter the closed volume.

According to a second aspect, a device for powder removal from a three-dimensional workpiece generated via additive manufacturing is provided. The device comprises a build cylinder fixture for mounting a build cylinder to the build cylinder fixture and a ring-shaped foil storage comprising a tube-like foil stored therein.

The ring-shaped foil storage may be configured to surround at least part of the build cylinder, when the build cylinder is mounted to the build cylinder fixture.

The foil may be powder-tight. Optionally, the foil may be gas-tight, in particular with regard to at least one of argon, nitrogen, and air.

All of the above optional features and details discussed above with regard to the method of the first aspect may apply to the device features of the second aspect, where appropriate. More precisely, the device for powder removal may comprise one or more of the elements discussed above with regard to the method aspect.

For example: The device may comprise at least one build cylinder as described above. The build cylinder may comprise at least one lid as described above. The device may comprise at least one funnel as described above. The device may comprise at least one manipulation device for bringing the build cylinder into the upside down position.

Preferred embodiments of the invention are described in greater detail with reference to the appended schematic drawings, wherein

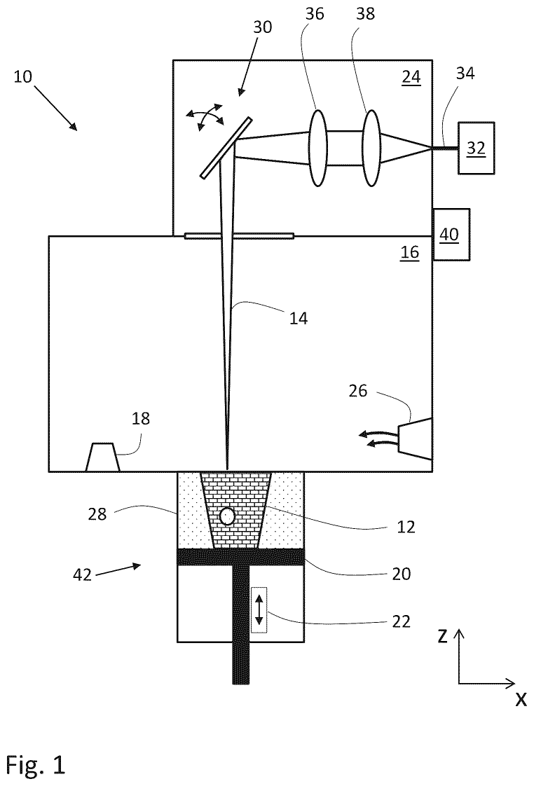

FIG. 1 shows a schematic representation of an apparatus for producing a three-dimensional workpiece via additive manufacturing using an exchangeable build cylinder;

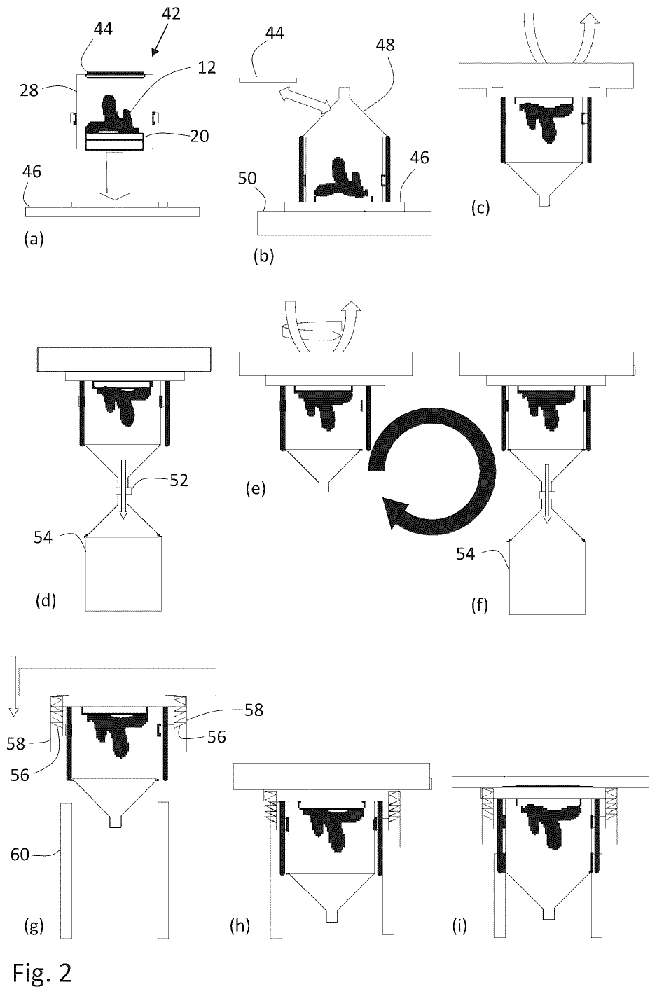

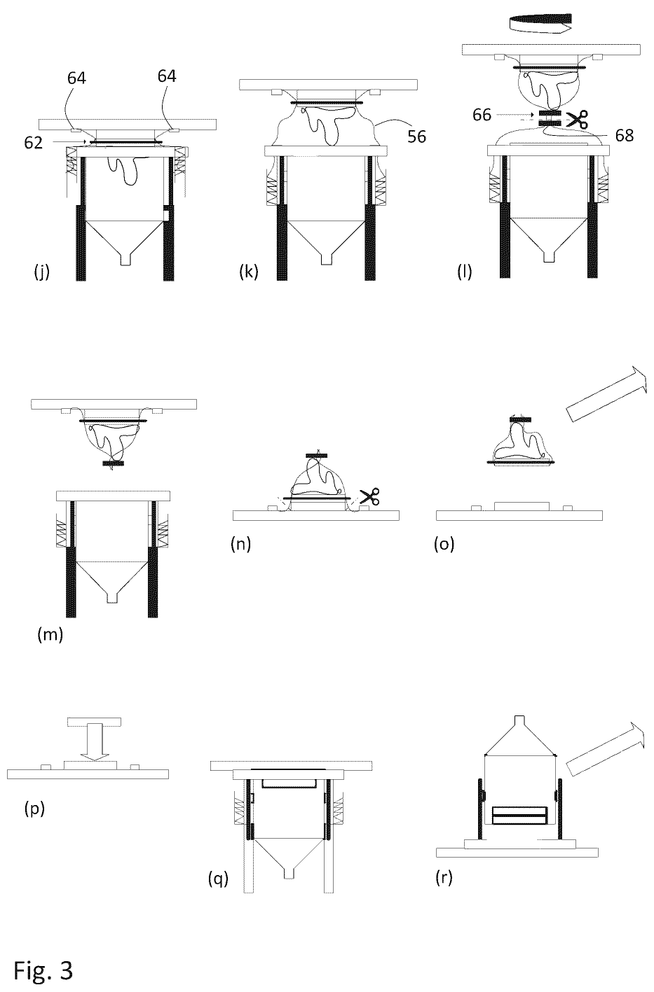

FIGS. 2-3 show a method for powder removal from a three-dimensional workpiece generated via additive manufacturing, according to the present disclosure, in the form of schematic side views;

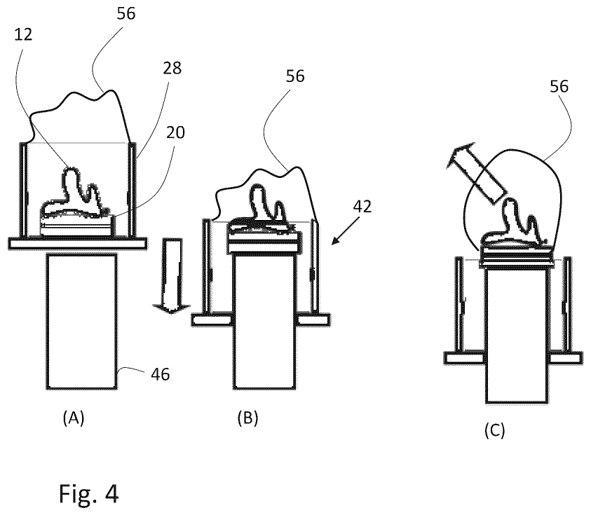

FIG. 4 shows a section of an alternative method for powder removal from a three-dimensional workpiece generated via additive manufacturing, according to the present disclosure, in the form of schematic side views;

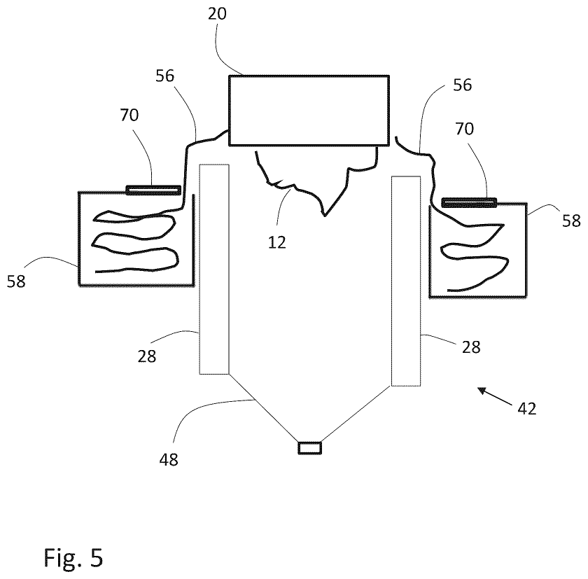

FIG. 5 shows a schematic side view of details of the build cylinder, the foil, and the workpiece;

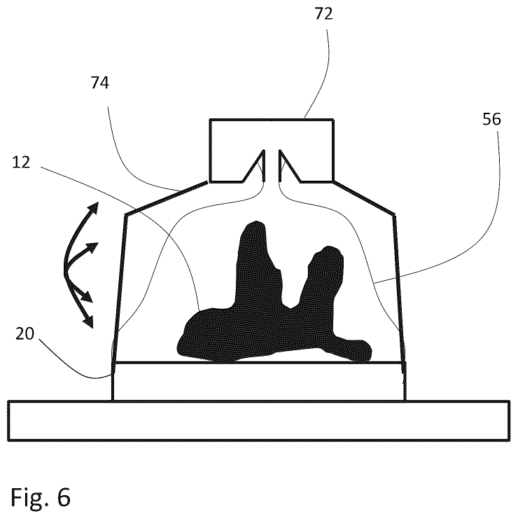

FIG. 6 shows a schematic side view of a workpiece enclosed by a foil, with a powder trap device; and

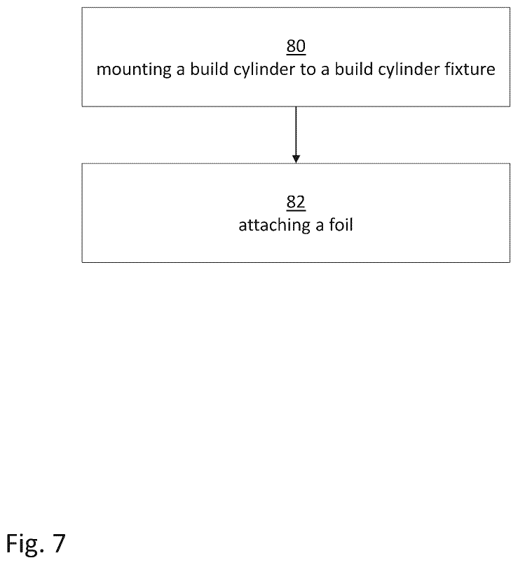

FIG. 7 shows a flow chart of a method for powder removal from a three-dimensional workpiece generated via additive manufacturing, according to the present disclosure.

FIG. 1 shows a schematic representation of an apparatus 10 for producing a three-dimensional workpiece 12. The apparatus 10 is well known to the person skilled in the art and may be, e.g., a typical additive manufacturing apparatus.

The principles of the apparatus 10 will therefore only be described briefly. For example, such an apparatus 10 may be an apparatus for selective laser melting or an apparatus for selective laser sintering, wherein one or more laser beams 14 may be used for selectively irradiating and solidifying subsequent layers of raw material powder.

The apparatus 10 for carrying out a process of selective laser melting as described below may serve as an example. Typical features of powder bed fusion are that a raw material powder is applied in layers and each layer is selectively irradiated and solidified in order to generate one layer of a workpiece 12 to be produced. After removing excess powder, and after optional steps of post processing (e.g., removing residual powder from the workpiece 12, removing one or more support structures), the final workpiece 12 is obtained.

FIG. 1 shows an apparatus 10 for producing a three-dimensional workpiece 12 by selective laser melting. The apparatus 10 comprises a process chamber 16. The process chamber 16 is sealable against the ambient atmosphere, i.e. against the environment surrounding the process chamber 16. A powder application device 18, which is arranged in the process chamber 16, serves to apply a raw material powder onto a carrier 20 (also referred to herein as a base plate 20). A vertical movement unit 22 is provided, such that the carrier 20 can be displaced in a vertical direction so that, with increasing construction height of the workpiece 12, as it is built up in layers from the raw material powder on the carrier 20, the carrier 20 can be moved downwards in the vertical direction.

As an alternative to the movable carrier 20, the carrier 20 may be provided as stationary (or fixed) carrier (in particular, with regard to the vertical z-direction), wherein the irradiation device 24 (see below) and the process chamber 16 are configured to be moved upwards during the build process (i.e., with increasing construction height of the workpiece 12). Further, both the carrier 20 and the irradiation device 24 may be individually movable along the z-direction.

A carrier surface of the carrier 20 defines a horizontal plane (an x-y-plane), wherein a direction perpendicular to said plane is defined as a vertical direction or build direction (z-direction). Hence, each uppermost layer of raw material powder and each layer of the workpiece 12 extend in a plane parallel to the horizontal plane (x-y-plane) defined above.

The apparatus 10 further comprises a gas inlet 26 for supplying an inert gas (e.g., argon) into the process chamber 16. A gas outlet (not shown) may be provided, such that a continuous stream of gas may be generated through the process chamber 16 by implementing a gas circuit. In a preferred embodiment, a unidirectional laminar flow is generated over the uppermost raw material powder layer.

The apparatus 10 further comprises an irradiation device 24 (also referred to as irradiation unit or optical unit) for selectively irradiating the laser beam 14 onto the uppermost layer of raw material powder applied onto the carrier 20. By means of the irradiation device 24, the raw material powder applied onto the carrier 20 may be subjected to laser radiation in a site-selective manner in dependence on the desired geometry of the workpiece 12 that is to be produced.

The irradiation device 24 comprises a scanning unit 30 configured to selectively irradiate the laser beam 14 onto the raw material powder applied onto the carrier 20. The scanning unit 30 is controlled by a control unit 40 of the apparatus 10. The scanning unit 30 may comprise one mirror tiltable with regard to two perpendicular axes. Alternatively, the scanning unit 30 may comprise two tiltable mirrors, each configured to be tilted with regard to a corresponding axis. The tiltable mirrors may be, e.g., galvanometer mirrors.

The irradiation device 24 is supplied with laser radiation from a laser beam source 32. The laser beam source 32 may be provided within the irradiation device 24 or outside the irradiation device 24, as shown in FIG. 1. In the first case, the laser beam source 32 may be regarded as being part of the irradiation device 24. In the latter case, the laser beam is generated by the laser beam source 32 and guided into the irradiation device 24 via an optical fiber 34. Alternatively, the laser beam may be guided into the irradiation device 24 through the air or through a vacuum, e.g., by using one or more mirrors.

From the laser beam source 32, the laser beam is directed to the scanning unit 30. The laser beam source 32 may, for example, comprise a diode pumped Ytterbium fiber laser emitting laser light at a wavelength of approximately 1070 to 1080 nm (i.e., in the infrared wavelength range).

The irradiation device 24 further comprises two lenses 36 and 38, which are configured to focus the laser beam 14 onto a desired focus position along the z-axis. In the embodiment shown in FIG. 1, both lenses 36 and 38 have positive refractive power. The lens 38 further upstream of the beam path is configured to collimate the laser light emitted by the fiber 34, such that a collimated or substantially collimated laser beam is generated. The lens 36 further downstream of the beam path is configured to focus the collimated (or substantially collimated) laser beam onto a desired z-position.

The control unit 40 comprises a processor and a memory, wherein, on the memory, instructions are stored for controlling the individual components of the apparatus 10. For example, the control unit 40 may be configured to control one or more of the vertical movement unit 22, the powder application device 18, a gas flow supplied by the gas inlet 26, and the irradiation device 24. A user input and output interface may be provided and connected or connectable to the control device 40. Further, the control unit 40 has an interface to receive workpiece data representative of a three-dimensional shape of the workpiece 12 to be produced.

The base plate 20 is part of a build cylinder 42 comprising the base plate 20 and sidewalls 28. The sidewalls 28 are vertical and, therefore, extend parallel to the z-direction and form, together with the base plate 20, a volume within which the workpiece 12 is located once the build process is finished. Further, unsolidified raw material powder is surrounding the workpiece 12, which is also referred to herein as residual powder. The build cylinder 42 of the apparatus 10 is exchangeable. That means that the build cylinder 42 (i.e., at least the sidewalls 28 and the base plate 20) can be removed from the apparatus 10 and brought to one or more post processing stations for further processing. For example, the build cylinder 42 can be moved to an unpacking station for powder removal from the workpiece 12 as described below.

Before the build cylinder 42 is disengaged from the process chamber 16, it may be closed with a lid (44, not shown in FIG. 1) to preserve an inert gas atmosphere within the build cylinder 42. For example, during the build process, the process chamber 16 and the build cylinder 42 may be flooded with inert gas such as argon. The lid 44 of the build cylinder 42 may prevent inert gas from leaving the build cylinder 42 and may prevent air from entering the build cylinder 42 once the build cylinder 42 is removed from the apparatus 10.

In the following, embodiments of methods for powder removal from the workpiece 12 will be discussed. The term “powder removal from the workpiece” generally refers to a removal of residual powder out of the build cylinder 42. The processes may be performed in a specially provided station for powder removal, also referred to as unpacking station. After the powder removal, the workpiece 12 may be moved to one or more further stations for further processing, wherein, e.g., remaining residual powder may be removed from the workpiece 12.

FIG. 2 shows a first part of two parts of a method for powder removal according to an embodiment of the present disclosure. FIG. 3 shows the second part. The individual steps of the method are labeled as (a) to (r) and are performed in the indicated order. The steps (a) to (r) are now discussed in detail. When, in the figures, not all elements are provided with a reference sign it should be appreciated that the same elements maintain their reference sign previously assigned.

In a first step (a), the build cylinder 42 is mounted to a build cylinder fixture 46. In this state, the build cylinder 42 is closed by a lid 44 and an inert gas atmosphere is preserved within the build cylinder 42. The build cylinder 42 is fixed to the fixture 46 with appropriate fixing means that enable a releasable connection. Further, the connection has to be strong enough to enable rotation of the build cylinder 42 via fixture 46. For example, screws, bolts, clamps, etc. may be used as fixing means. The build cylinder fixture 42 may be or may comprise a simple element such as a plate.

In step (b), the lid 44 is removed and replaced by a funnel 48. The funnel 48 is positioned at an upper opening of the build cylinder 42, where the lid 44 was positioned before. Further, a robot end effector 50 is shown in section (b), wherein the fixture 46 is attached to the end effector 50. The fixture 46 may either be attached to the end effector 50 in a step of the process (e.g., in step (b)) or may have been attached to the end effector 50 the entire time (i.e., also in step (a), not shown). The robot end effector 50 enables movement of the build cylinder via the fixture 46 around at least one axis (in particular around a horizontal axis). In an alternative embodiment, the build cylinder fixture 46 and the robot end effector 50 form one integral element.

In step (c) the build cylinder 42 is brought into an upside down position via a movement of the end effector 50. More precisely, the end effector 50 and, thereby the build cylinder 42, is rotated around a horizontal axis by 180°, such that the build cylinder 42 is upside down. In other words, an opening of the build cylinder 42 that was directed upwards at the beginning of the process (upright position) is facing downwards in the upside down position. In step (c), additional movements around the horizontal axis, but also around further (e.g., horizontal or vertical) axes may be carried out. Further, step (c) may comprise a vibration of the end effector 50 to shake powder from the workpiece 12. At the end of step (c) a certain amount of residual powder is accumulated in a lower part of the funnel 48 when the build cylinder 42 is in the upside down position.

In step (d), a storage container 54 is connected to the funnel 48 via a connection member 52 such as a clamp. The storage container 54 is provided below the build cylinder 42 and the funnel 48, such that the residual powder from the funnel 48 falls into the storage container 54 once a valve (not shown) of the funnel 48 is opened. The storage container 54 has an opening that fits to an outlet of the funnel 48. For example, a top part of the storage container 54 may have a shape of a reverse funnel (see FIG. 2).

In step (e), further rotational movements along one or more axes and/or lateral movements along one or more directions are performed. This causes residual powder that remained in the build cylinder 42 after step (d) to detach from the workpiece 12 and/or from the build cylinder 42 and to fall downwards into the funnel 42, which is closed again via its valve.

In step (f), the storage container 54 is connected again, similar to step (d) and the residual powder accumulated in step (e) falls down into the storage container 54.

In step (g), a foil storage 58 is provided. The foil storage 58 is ring-shaped in a sense that it surrounds the build cylinder 42. In other words, it is circumferential. The foil storage 58 may therefore have a square shape, a rectangular shape, or a circular shape, for example. The foil storage 58 holds a tube-like foil 56. In other words, a tube-like foil 56 is stored in the foil storage 58 in folded form. The foil 56 is transparent and may also be referred to as an endless foil. The term endless foil refers to the fact that it may be used for several processes and not only for one process. For each process, only a part of the endless foil 56 is used and detached, but the rest of the endless foil 56 stays within the storage 58 and can be used for following processes.

In alternative methods, the foil storage 58 may already be attached to or be part of the build cylinder fixture 46 when the build cylinder 42 is attached in step (a). Further, the foil storage may be provided in one of the steps (b) to (d).

A rack 60 is provided below the build cylinder 42 and the build cylinder 42 is moved downwards towards the rack 60 in step (g).

In step (h), the build cylinder 42 rests on the rack 60 and is held by the rack 60.

In step (i), the base plate 20 is released from the rest of the build cylinder 42. More precisely, a releasable connection between the base plate 20 and the sidewalls 28 is released.

In step (j), the build cylinder fixture 46 is moved upwards, together with the base plate 20 mounted to the build cylinder fixture 46 and together with the workpiece 12 held by the base plate 20.

As shown in FIG. 3, an end section of the ring-shaped foil 56 is attached to the build cylinder fixture 46 via attachment means 64 (such as clamps). The connection of the foil 56 to the fixture 46 may not be powder-tight or air-tight, because a second connection of the end section of the ring-shaped foil 56 is made to the base plate 20. The connection of the foil 56 to the base plate 20 is made by using a clamp device 62 surrounding the base plate 20. In this way, the clamp device 62 clamps the foil 56 between the base plate 20 and the clamp device 62. A groove in the base plate 20 may be provided, such that the clamp device 62 engages in said groove. The connection between the foil 56 and the base plate 20 is powder-tight or gas-tight, with regard to an atmosphere, in which the workpiece 12 is provided and a surrounding atmosphere (e.g., air).

The connection of the foil 56 to the build cylinder fixture 46 may be made in step (j) or may be made, e.g., in step (g), where the foil storage 58 is provided.

In step (k), the build cylinder fixture 46, together with the base plate 20 and the workpiece 12 is moved further upwards, wherein the workpiece 12 is enclosed in the foil 56. In other words, the foil 56 laterally encloses the workpiece 12, wherein a closed atmosphere is guaranteed since the funnel 48 closes the atmosphere, in which the workpiece 12 is provided, from below.

In step (l), the tube-like foil 56 is pinched off with a pinching member 66, such as a cable tie, an adhesive tape, a clamp, etc. With the pinching off, it is ensured that a closed atmosphere exists around the workpiece 12 even after the foil is cut (as indicated via a scissor in FIG. 3). In order to maintain the atmosphere within the build cylinder 42, a second pinching member 66 may be used for pinching off the foil 56 before the foil is cut between the two pinching members 66, 68. Optionally, the foil is twisted around a vertical axis to enhance the pinching off.

In step (m), the build cylinder fixture 46 is further lifted upwards from the build cylinder 42. The workpiece 12 is fully enclosed by the pinched off foil 56, thereby forming a closed atmosphere around the workpiece 12.

In step (n), the fixture 46 is rotated back to its initial, upright position (i.e., rotated for 180° around a horizontal axis). The foil is cut between the attachment means 64 and the clamp device 62.

In step (o), the base plate 20 is removed from the fixture 46, together with the workpiece 12 enclosed by the foil 56.

In step (p), a new base plate 20 is attached to the fixture 46.

In step (q), the fixture 46 is rotated back to an upside down position and the new base plate 20 is merged with the sidewalls 28 of the build cylinder 42.

In step (r), the build cylinder 42 with its new base plate 20 is rotated back around a horizontal axis to an upright position. The build cylinder 42 (exchangeable build cylinder 42) can now be reused for a new build process in an additive manufacturing process.

With regard to the above method, it should be noted that steps (e) and (f) are optional. Further, attaching the foil 56 to the fixture 46 is optional. In some situations, it may be sufficient to attach the foil 56 to the base plate 20.

FIG. 4 shows steps of a second embodiment that may be regarded as an alternative method as compared to the method of FIGS. 2 and 3. FIG. 4 shows three steps (A) to (C) that are carried out after step (f) of the method of FIGS. 2 and 3. Hence, up to step (f), the method of the second embodiment is the same as that of the first embodiment.

However, in the second embodiment, the build cylinder 42 does not stay in its upside down position but is brought back to an upright position, as shown in FIG. 4 (A). Further, for the consideration of steps (A) to (C), the post 46 shown in FIG. 4 is the build cylinder fixture 46.

In step (A), the build cylinder 42 is mounted onto the build cylinder fixture 46. Further, a foil 56 is attached to the upper ends of the sidewalls 28. In this case, the foil 56 is not tube-like (i.e., with two openings) but it may be planar or in the form of a bag (i.e., with one opening). In step (A), the foil 56 covers the volume within the build cylinder 42 entirely.

In step (B), the sidewalls 28 of the build cylinder 42 are lowered. Alternatively, the base plate 20 is lifted upwards with regard to the sidewalls 28. The foil 56 stays attached to the upper ends of the sidewalls 28.

Step (C) is carried out when the base plate 20 has substantially reached a level of the upper ends of the sidewalls 28. In step (C), the foil 56 is detached from the sidewalls 28 and attached to the base plate 20 on which the workpiece 12 rests. The workpiece 12 is now fully enclosed by the foil 56 in a closed volume.

In a following step, the base plate 20 may be removed from the build cylinder fixture 46 for further processing.

FIG. 5 shows a schematic side view of the build cylinder 42 according to a method of the first embodiment, i.e., when the foil 56 is attached in the upside down position.

FIG. 5 may correspond to step (j) of FIG. 3. In addition to the elements discussed above with regard to FIGS. 2 and 3, antistatic brushes 70 may be provided at an outlet region of the foil storage 58. This may avoid electrostatic charging of the foil 56 and may prevent powder from sticking to the foil 56.

Further, in order to prevent the foil 56 from electrostatic charge, the foil 56 may comprise an antistatic coat. As a foil 56, a single use foil may be used.

For the fixation of the foil 56 to the base plate 20, according to steps (j) or (C) above, the following may apply. The foil 56 is attached with a dense clamp device 62 to the base plate 20. For example, elements out of rubberized metal may be used, wherein the clamp device 62 surrounds the base plate 20. The clamp device may be rubberized in order to improve tightness and avoid slipping off.

An opening may be provided in the foil 56 as a gas inlet. Inert gas may be provided into a volume within the foil. Further, an opening may be provided in the foil 56 for sticking a tip of a vacuum device though the foil and for manipulating the vacuum device in the volume enclosed by the foil. One or more sieving devices may be provided in the funnel 48 for sieving out coarse particles from the residual powder.

FIG. 6 shows an arrangement that may apply to both the first and the second embodiment. In the upright position of the workpiece 12, at an upper part of the foil 56, a powder trap device 72 is attached to the foil 56. For example, the pinching member 66 in step (l) may be the powder trap device 72. Alternatively, the powder trap device 72 may be attached afterwards, e.g., by removing the pinching member 66.

The powder trap device 72 is held by a holding bracket 74, such that the powder trap device 72 does not fall onto the workpiece 12. The powder trap device 72 has a powder entry section with sidewalls pointing inwards, i.e., in a direction into an inner volume of the powder trap device 72. In the upright position, powder is trapped in a region besides these sidewalls. In the upside down position, powder can pass the powder entry section and enter the powder trap device 72.

Hence, when the powder trap device 72 is attached, the work piece 12 may be rotated around one or more horizontal axes for one or more times in order to collect as much residual powder in the powder trap device 72 as possible. In other words, the work piece 12 (and the entire system shown in FIG. 6) may be brought into the upside down position and into the upright position for several times in a row. The rotation of the system may be controlled by an operator visually, since the foil 56 is transparent. Additionally, vibration may be carried out. Further, an inside volume within the foil 56 may be flooded with argon.

Further, in all embodiments discussed herein, one or more of the following powder treatment steps may be carried out in a volume enclosed by the foil 56.

The volume may be flooded with argon. One or more openings (e.g., for manipulation) may be provided in the foil 56. A vibration device may be installed from the outside, through the foil 56, at the workpiece 12. Manual manipulation, e.g., of the workpiece 12, is possible through the foil 56. An opening for a vacuum device may be provided in the foil 56. It is possible to provide a blower under the foil 56. In the upside down position, a lower part of the foil 56 may be pinched off, e.g., via twisting, wherein powder is trapped in said lower part. In this way, residual powder may be separated from the remaining volume within the foil 56. A powder trap 72 as discussed above may be attached to an end of the foil 56. An outlet system may be provided via a tube provided at the end of the tube-like foil 56.

FIG. 7 shows a flowchart of a method for powder removal from a three-dimensional workpiece generated via additive manufacturing according to the present disclosure. The method comprises a step 80 of mounting a build cylinder to a build cylinder fixture. The build cylinder comprises a base plate holding the three-dimensional workpiece and sidewalls separably attached to the base plate. The build cylinder comprises residual powder from an additive manufacturing process of the three-dimensional workpiece. The method further comprises a step 82 of attaching a foil to the build cylinder fixture and/or to the base plate. The details discussed above may apply to the method of FIG. 7.

One or more embodiments of the present technique may have at least one of the following advantages. By providing the foil 56, the workpiece 12 may be in a closed (e.g., inert) volume for all or at least most of the time of the process. Hence, contact of the workpiece and/or of the residual powder with surrounding atmosphere may be reduced or even avoided. Residual powder can be removed efficiently. Further, a contamination of a surrounding atmosphere may be reduced and, thereby, operational safety may be enhanced.

1. A method for powder removal from a three-dimensional workpiece generated via additive manufacturing, the method comprising:
mounting a build cylinder to a build cylinder fixture, wherein the build cylinder comprises a base plate holding the three-dimensional workpiece and sidewalls separably attached to the base plate, and wherein the build cylinder comprises residual powder from an additive manufacturing process of the three-dimensional workpiece; and
attaching a tube-like foil to the build cylinder fixture and/or to the base plate, wherein the workpiece is enclosed by the tube-like foil in a manner that the workpiece is within an inner volume defined by the tube-like foil.

2. The method of claim 1, further comprising
separating the base plate from the build cylinder, while the tube-like foil stays attached to the build cylinder fixture and/or to the base plate.

3. The method of claim 2, wherein
in the step of attaching, an opening section of the tube-like foil is attached to the build cylinder fixture and/or to the base plate; and
the opening section of the tube-like foil corresponds to one end section of two opposite end sections of the tube-like foil.

4. The method of claim 3, further comprising:
after the step of separating the base plate from the build cylinder, pinching off the tube-like foil in a region of the tube-like foil between the one end section and the other one of the two opposite end sections, such that the tube-like foil forms a closed volume around the three-dimensional workpiece.

5. The method of claim 4, wherein the opening section of the tube-like foil is attached to the base plate by using a clamp device surrounding the base plate and clamping the tube-like foil between the clamp device and the base plate.

6. The method of claim 3, further comprising
removing the base plate from the build cylinder fixture.

7. The method of claim 6, further comprising:
reusing the build cylinder fixture for a further process according to the method of claim 1.

8. The method of claim 3, wherein the tube-like foil is stored in folded form in a foil storage, and, optionally, wherein the foil storage surrounds at least part of the build cylinder.

9. The method of claim 1, further comprising:
removing a lid of the build cylinder and replacing the lid with a funnel.

10. The method of claim 2, further comprising:
after the step of mounting, rotating the build cylinder around a horizontal axis, such that the build cylinder is brought into an upside down position.

11. The method of claim 10, further comprising:
removing a lid of the build cylinder and replacing the lid with a funnel; and
opening a valve of the funnel, such that at least part of the residual powder flows downwards into a storage container.

12. The method of claim 11, wherein the powder, that flows downwards, passes at least one sieving station to remove coarse particles from the powder.

13. The method of claim 10, wherein the steps of attaching and separating are performed in the upside down position.

14. The method of claim 1, further comprising:
vibrating and/or rotating the build cylinder and/or the base plate.

15. The method of claim 1, further comprising:
after the step of attaching, inserting a tip of a vacuum device through an opening of the foil and vacuuming an inside region of the foil with the vacuum device to remove at least part of the residual powder.

16. The method of claim 5, further comprising:
removing the clamp device and attaching a powder trap device to the tube-like foil, wherein the powder trap device has a powder entry section with sidewalls pointing inwards; and
rotating the build cylinder around a horizontal axis, such that at least part of the residual powder is trapped inside the powder trap device.

17. The method of claim 10, further comprising:
in the upside down position, pinching off a section of the tube-like foil at a lower part of the tube-like foil, such that at least part of the residual powder is trapped within a closed volume formed by the tube-like foil.

18. The method of claim 1, wherein the foil is powder-tight and, optionally, wherein the foil is gas-tight, in particular with regard to at least one of argon, nitrogen, and air.

19. A device for powder removal from a three-dimensional workpiece generated via additive manufacturing, the device comprising:
a build cylinder fixture for mounting a build cylinder to the build cylinder fixture, the build cylinder comprising a base plate holding the three-dimensional workpiece; and
a foil storage comprising a tube-like foil stored therein, wherein the foil storage is configured such that the workpiece can be enclosed by the tube-like foil in a manner that the workpiece is within an inner volume defined by the tube-like foil.

20. The device of claim 19, wherein the foil storage is configured to surround at least part of the build cylinder, when the build cylinder is mounted to the build cylinder fixture.

21. The device of claim 19, wherein the foil is powder-tight and, optionally, wherein the foil is gas-tight, in particular with regard to at least one of argon, nitrogen, and air.
